(19) United States
(12) Patent Application Publication
(10) Pub. No.: US 2018/0356890 A1
(43) Pub. Date: Dec. 13, 2018

(54) WEARABLE DEVICE

(71) Applicant: Microsoft Technology Licensing, LLC, Redmond, WA (US)

(72) Inventors: Haiyan ZHANG, Cambridge (GB); John Franciscus Marie HELMES, Steyl (NL); Nicolas VILLAR, Cambridge (GB)

(21) Appl. No.: 15/638,115

(22) Filed: Jun. 29, 2017

(30) Foreign Application Priority Data
Jun. 9, 2017 (GB) 1709227.1

(51) Int. Cl. G06F 3/01

(52) U.S. Cl. CPC G06F 3/016; A61H 23/02

(57) ABSTRACT

A wearable device is described which comprises a plurality of actuators. The actuators in the wearable device are adjustable relative to one another in terms of their position and in various examples, the actuators may be adjustable relative to one another in terms of their duty cycle, power and/or position based on sensor data.

### CROSS-REFERENCE TO RELATED APPLICATIONS

This application claims priority to GB application serial number 1709227.1, filed Jun. 9, 2017, the entirety of which is hereby incorporated by reference herein.

### BACKGROUND

Haptic stimulation systems apply forces or vibrations to stimulate a user's sense of touch. Touch-screen devices may use haptic feedback to indicate key presses to a user; games controllers may use haptic feedback to increase video game immersion (e.g. by vibrating in response to a collision or explosion within a video game) and smart watches may use haptic feedback to provide silent alerts to the wearer.

The embodiments described below are not limited to implementations that solve any or all of the disadvantages of known haptic stimulation systems.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A wearable device is described which comprises a plurality of actuators. The actuators in the wearable device are adjustable relative to one another in terms of their position and in various examples, the actuators may be adjustable relative to one another in terms of their duty cycle, power and/or position based on sensor data.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows schematic diagrams of three example wearable devices;

FIG. 2 is a flow diagram of an example method of operation of a system comprising a wearable device;

FIG. 3 shows schematic diagrams of two example wearable devices;

FIG. 4 is a schematic diagram of a further example wearable device; and

FIG. 5 is a flow diagram of another example method of operation of a system comprising a wearable device.

Like reference numerals are used to designate like parts in the accompanying drawings.

### DETAILED DESCRIPTION

The detailed description provided below in connection with the appended drawings is intended as a description of the present examples and is not intended to represent the only forms in which the present example are constructed or utilized. The description sets forth the functions of the example and the sequence of operations for constructing and operating the example. However, the same or equivalent functions and sequences may be accomplished by different examples.

As described above, existing wearable devices may use haptic stimulation to provide silent alerts to the wearer (e.g. for alarms, calendar reminders, incoming messages, etc.).

Described herein is a wearable device which uses haptic actuation for therapeutic stimulation and in various examples, the wearable device may be worn close to a joint and used to affect (e.g. reduce or stabilize) involuntary movement of the joint or limb. The wearable device described herein may be used to alleviate (e.g. reduce) some symptoms of a condition (whether temporary or permanent) which affects motion or control of the limbs and one example is Parkinson's disease. Symptoms of Parkinson's disease typically include tremors (i.e. involuntary shaking of parts of the body, such as the hand), slow movement and stiff and inflexible muscles.

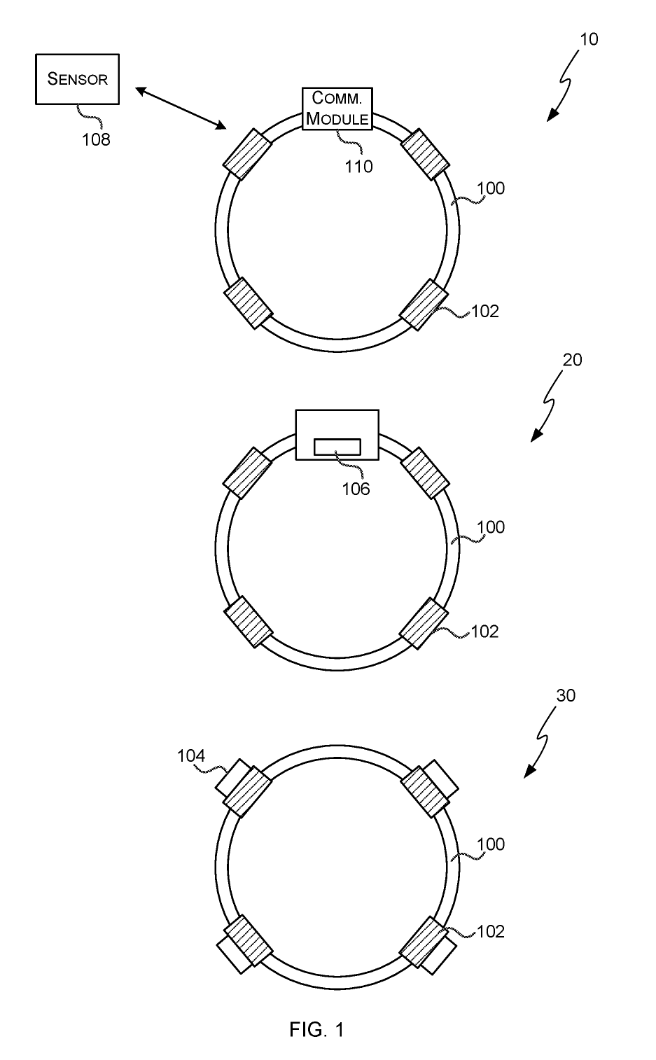

The wearable device described herein comprises a plurality of actuators (e.g. electro-mechanical actuators) that are spatially distributed within the wearable device. For example, where the wearable device is worn around a limb (e.g. around the arm close to either the wrist or elbow), the wearable device 10, 20, 30 comprises a band 100 along which the actuators 102 are spatially distributed, as shown in FIG. 1. In various examples the actuators 102 are movably mounted on the wearable device (e.g. on band 100) so that their position relative to one another can be adjusted. In various examples the actuators 102 (from the plurality of actuators) are adjustable relative to one another in terms of duty cycle, power and/or position in response to sensor data. The sensor(s) 104, 106, 108 that generate the sensor data may be located in the wearable device (e.g. with one sensor 104 proximate to each actuator and/or one or more sensors 106 spatially separated from all of the actuators), separately attached to the wearer or located within a computing device (e.g. a tablet or smart phone) that communicates with the wearable device (e.g. wirelessly, using WiFi™, Bluetooth™ or other protocol).

The term ‘duty cycle’ is used herein to refer to the intermittent, periodic operation of the actuators (e.g. which may be represented by a square wave of a particular frequency) and is distinct from the frequency of vibration the actuators (which may be fixed and is significantly higher than the frequency of the square wave). In various examples the frequency of vibration of the actuators may be around 200 Hz and the duty cycle of the actuators may be 50% over a period of 1 second (i.e. a repeating pattern where the actuators are vibrating at 200 Hz for 500 ms and off for 500 ms). Whilst control of the duty cycle is described herein, it will be appreciated that the frequency of the actuators may additionally (and separately) be controlled, e.g. to ensure that the actuator operates at its resonant frequency.

Wearable devices are typically constrained both in terms of energy capacity (e.g. battery capacity) and physical size (and in various examples, weight). If a user is to wear the device for 12-16 hours a day, the battery life is ideally at least 12-16 hours and the device must be sufficiently small and light that it does not adversely affect the movement of the wearer.

By adjusting the duty cycle, power and/or position of the actuators, and in various examples adjusting one of more of these aspects in response to sensor data, the efficacy of the actuation (e.g. how well the user perceives the actuation or how effective the wearable device is at alleviating symptoms such as tremors) and the efficiency of the system can be improved. By improving the efficacy and efficiency of the wearable device, the power consumption of the wearable device is reduced. As in many examples the wearable device is powered from a local energy store (e.g. a battery or super-capacitor), by reducing the power consumption, the operating life of the device (e.g. between re-charging operations) is increased and/or the physical size of the energy store can be reduced.

The efficacy of the actuation is dependent upon one or more different factors, including the location of the actuator on the wearer's body (e.g. on their wrist). For example, an actuator placed against a carpal bone will couple vibration more effectively into the wearer's arm compared to an actuator placed against a muscle or soft tissue. The physiology of the body (e.g. diameter of the wrist, location of carpal bones and tendons in the wrist, etc.) varies from person to person and consequently the optimum actuator position varies from person to person. Another factor which will affect the efficacy of the actuation is how closely the actuator is in contact with the body and this may be dependent on how tightly the wearable device has been fastened (e.g. how tightly the band of the wearable device has been fastened around the wearer's wrist). Consequently, even for a single wearer, the efficacy of the wearable device may vary over time, e.g. because as the wearer removes the wearable device and then puts it back on again, the manner in which it is attached, such as the tightness and precise position, may vary. As described below, sensor data may, in various examples, be used to assess the coupling of an actuator to the wearer's body.

The actuators 102 may, for example, be eccentric-mass vibration motors, linear-resonant actuators (LRAs) or piezo-electric elements. With these actuators there is a correlation between the magnitude (or force) of the actuation and the amount of power used to drive the actuator. Consequently, the efficiency of the actuation and hence efficiency of the wearable device is dependent upon the efficacy of the actuation. If the efficacy of the actuation is increased (i.e. such that the coupling of the vibration from the actuator to the wearer is increased), then the magnitude of the actuation that is required to achieve the desired effect is reduced (compared to a situation where the coupling is poorer) and hence the power used to drive the actuator can be reduced.

FIG. 1 shows three example wearable devices 10, 20, 30 that each comprise a plurality of actuators 102 mounted in or on a band 100. As shown in FIG. 1, the actuators 102 are spatially distributed along (or around) the band and whilst FIG. 1 shows a continuous band 100, in other examples the band may not be continuous (e.g. it may be C-shaped) or may have a clasp, buckle or other connecting mechanism to enable the band to be fastened around a limb. As described above, the actuators 102 (from the plurality of actuators) are adjustable relative to one another in terms of duty cycle, power and/or position, and in various examples, one or more of these aspects are adjustable in response to sensor data.

In the first example wearable device 10, the sensor(s) 108 that generate the sensor data are not located in the wearable device 10 but are instead remote from the wearable device 10 but in communication with the wearable device, e.g. via a communication module 110 in the wearable device, and any suitable wireless communication protocol may be used (e.g. WiFi™, Bluetooth™ ANT+, Zigbee or a proprietary protocol that ensures low latency and security). In this example, the sensor(s) 108 may not directly detect the motion of the actuators 102 but instead may detect the motion of the wearer. For example, where the wearable device 10 is worn on a user's wrist or arm, the sensor(s) 108 may be implemented in or on a writing implement (e.g. in a stylus which is used to write on a touch-sensitive or other sensing surface or in/on a pen, pencil or other traditional writing implement) or in a surface on which the user writes (e.g. a tablet computer, touch-sensitive display, etc.). In such an implementation, the sensor(s) 108 may detect involuntary motion of the wearer and the system may gradually adjust the operation of the actuators 102 such that the detected involuntary motion is also reduced.

In the second example wearable device 20, the sensor(s) 106 that generate the sensor data are located in the wearable device (i.e. such that the wearable device comprises one or more sensors) and are spatially separated from all of the actuators. In this example, the sensor(s) 106 detect the motion of the actuators 102 as a consequence of the transmission of the motion through the wearer's limb.

In the third example wearable device 30, the sensors 104 that generate the sensor data are located in the wearable device (i.e. such that the wearable device comprises a plurality of sensors) with one sensor 104 proximate to each actuator 102. In this example, each sensor 104 directly detects the motion of the proximate actuator 102. In a variation on this example, the co-located sensor 104 and actuator 102 may be integrated (e.g. where the actuator is an LRA), such that the sensor data comprises the back-EMF (electromotive force) generated by the actuator 102. It is known to use the back-EMF to perform auto-resonance tracking such that it can be ensured that a LRA is kept vibrating at its resonant frequency. This same back-EMF signal (which chances as the magnet moves closer or further away from the drive electrodes) may be additionally used to provide an estimate of the coupling of the vibration of the actuator to the body and hence to determine whether the actuators should be enabled or disabled or otherwise adjusted (e.g. in terms of duty cycle, power or position). In various examples, a calibration step may be used to determine the expected back-EMF signal for both a well-coupled LRA and a poorly-coupled LRA and then these values may be used when determining, from the back-EMF, how closely the actuators are coupled to the body of the wearer.

The sensor(s) 104, 106, 108 may, for example, comprise accelerometers, gyroscopes, heart rate sensors, electromyography (EMG) sensors that detect muscle activity, etc. Where the sensors are not located in the wearable device (e.g. as in the first example shown in FIG. 1), the sensor(s) 108 may comprise a touch-screen or imaging system which may detect the motion of a user's finger (or other part of the body) or the motion of a stylus (or other object) held by the user. In various examples, the sensors 104, 106, 108 may sense user input (e.g. they may be touch-sensors or buttons).

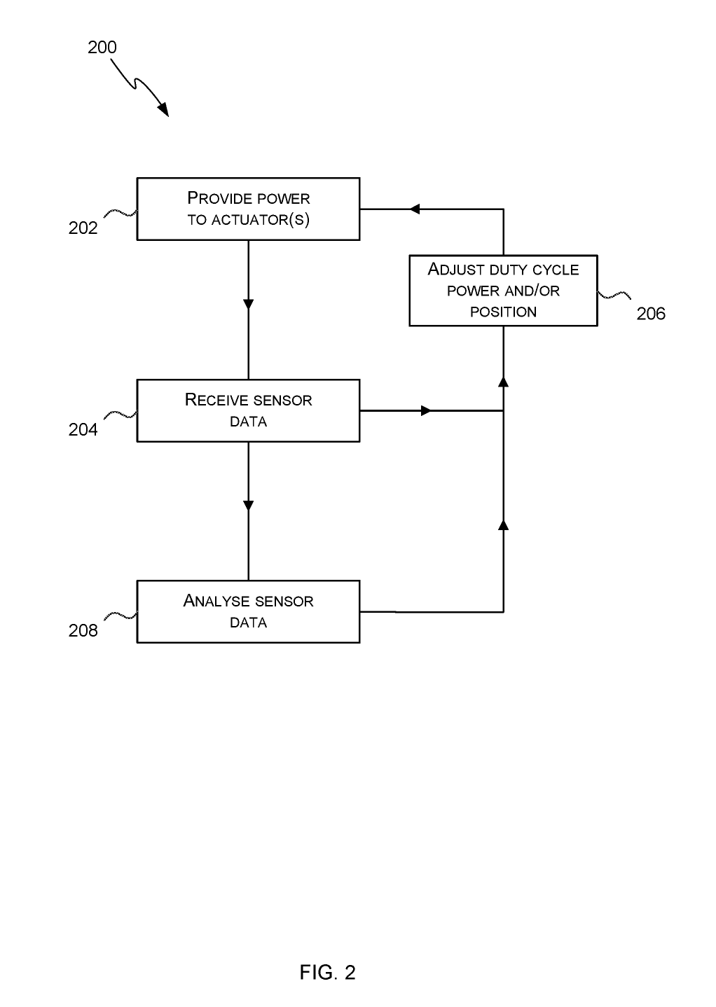

FIG. 2 is a flow diagram of a method of operation of a wearable device as described herein or of a system comprising a wearable device as described herein. As described above and shown in FIG. 2, the actuators in the plurality of actuators are adjusted in terms of duty cycle, power and/or position in response to sensor data. In various examples, as part of a calibration phase, power is provided to one or more of the actuators (block 202) and sensor data is received (block 204). This is then repeated for different values of duty cycle, power and/or position (as adjusted in block 206) and/or different actuators before all the sensor data is analyzed (block 208) to identify optimum settings for the of duty cycle, power and/or position of the actuators and then the duty cycle, power and/or position of the actuators may be set to the identified optimum settings (in block 206) for an operational phase of the wearable device. In other examples, however, the sensor data which is received (in block 204) for a particular setting of duty cycle, power and/or position and/or actuator may be analyzed (in block 204) and the analysis may be used as a feedback loop to determine what adjustment to make to the duty cycle, power and/or position of the actuators (in block 206). In various examples, a calibration phase (as described above) may be used to determine initial settings of duty cycle, power and/or position and then the sensor data may be used in a feedback loop during the operational phase to continuously or periodically adjust the settings of duty cycle, power and/or position of one or more of the actuators.

In various examples, the sensor data may be representative of explicit user input (e.g. where the sensors 104, 106, 108 detect user input, as described above). In various examples, a user may touch an actuator 102 which they wish to adjust and therefore touch the co-located sensor 104. The adjustment of the actuator (e.g. in terms of duty cycle, power and/or position) may be dependent upon the nature of the touch interaction (as determined from the sensor data). For example, a single tap of an actuator (as detected by a co-located sensor) may toggle between enabling the actuator (i.e. setting the power to a predefined level) or disabling the actuator (i.e. setting the power to zero). In the same, or a different, example, a different touch interaction (e.g. a double tap) may change the duty cycle of the actuator.

The analysis of the sensor data (in block 208) and the adjustment of the duty cycle, power and/or position (in block 206) based on the analysis may be performed in the wearable device 10, 20, 30 (e.g. in a control module not shown in FIG. 1). In other examples, however, the analysis of the sensor data (in block 208) may be implemented external to the wearable device 10, 20, 30, e.g. in a computing device with which the wearable device communicates (e.g. a computing device to which the wearable device is tethered via a wireless link) or in a remote computing device (e.g. a computing device in a data center). In examples where the analysis (in block 208) is not performed within the wearable device, the adjustment of the duty cycle, power and/or position of the actuators (in block 206) is performed within the wearable device. In various examples where the sensors(s) 108 are external to the wearable device 10, the module that performs the analysis of the sensor data (in block 208) may be co-located with the sensor(s) 108 (e.g. the sensor(s) 108 and analysis module may be located in a computing device to which the wearable device is tethered).

In various examples the actuators 102 (from the plurality of actuators and in any of the wearable devices 10, 20, 30 shown in FIG. 1) may be adjustable relative to one another in terms of position in response to sensor data. By adjusting the relative position of the actuators, the efficacy of the actuation may be improved and hence the efficiency of the wearable device may be improved.

To provide this adjustability, the actuators 102 may be movably mounted on the wearable device (e.g. such that they can slide along the band 100 in the examples shown in FIG. 1). A user may be able to manually move the actuators 102 and/or they may be movable automatically using motors or other electrically controlled elements. Alternatively, the actuators 102 may be in fixed positions on the wearable device but may be selectable such that the relative positions of the active (i.e. powered) actuators can be changed (e.g. such that only the best-perceived actuators are activated and the other actuators are deactivated to conserve power). Referring to the examples shown in FIG. 1 in which each wearable device 10, 20, 30 comprises four actuators 102, the relative position of the active actuators may be varied by selecting two or three of the four actuators 102 at any time and only providing power to the selected actuators.

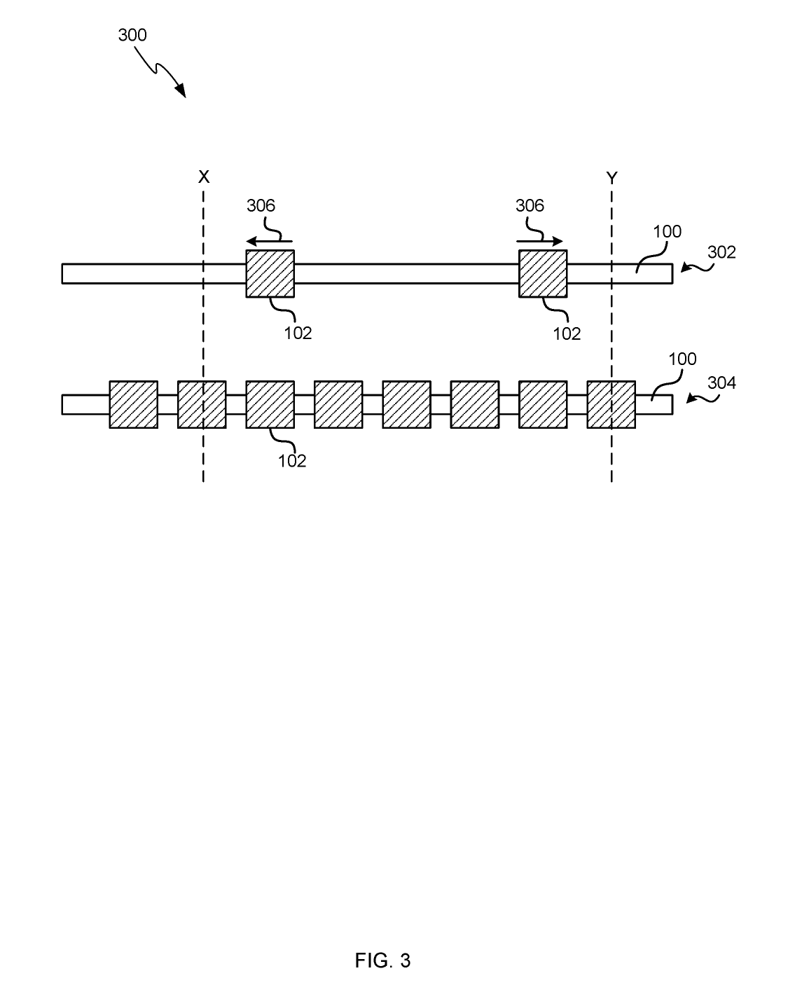

The two different implementations for adjusting the relative position of the actuators 102 are shown graphically in FIG. 3. FIG. 3 shows two wearable devices 301, 302 each comprising a plurality of actuators 102 and whilst the wearable devices are both drawn linearly, this is for purposes of illustration only and the wearable devices may be curved or circular bands (e.g. as shown in FIG. 1). If the optimum positions of actuators are at positions X and Y (as determined using data from one or more sensors), the efficacy and efficiency of the first wearable device 301 may be improved by moving the actuators 102 along the band 100 as indicated by the arrows 306. Similarly, the efficacy and efficiency of the second wearable device 302 may be improved by activating the actuators 102 which are located closest to positions X and Y and not activating the other actuators 102. Whilst this second example wearable device 302 is described in terms of adjusting the relative position of the actuators 102, it may alternatively be considered to be an adjustment of the relative power of the actuators, with those actuators located closest to positions X and Y being powered and the other actuators having their power set to zero.

The optimum positions (e.g. X and Y in the example of FIG. 3) are determined dynamically using sensor data and may be determined by comparing sensor data for different positions of active actuators either as part of a calibration phase or during operation using the sensor data in a feedback loop. An optimum actuator position may be defined in a number of different ways. In various examples, the optimum position may be one that results in the largest detected vibration from the actuator (e.g. as detected by a sensor 104, 106 in the wearable device 20, 30). In other examples, the optimum position may be one that results in the biggest reduction in involuntary movement of the user (e.g. as detected by a sensor 104, 106 in the wearable device 20, 30 or a separate sensor 108). A calibration phase (e.g. as described above) may be used to determine a pre-defined number of optimum positions (which may, for example, depend on the size of the wearer and/or the position in which the wearable device is attached and/or on the nature of the condition suffered by the wearer) and then in an operational phase (i.e. after the calibration phase), actuators may be powered at each of the optimum positions. For example, in a calibration phase the number of optimum positions may be incrementally increased until the involuntary movement of the user stops.

In examples where the actuators are movable, this may be achieved by moving the actuators (either automatically or manually) to different positions on the wearable device (in block 206), activating the actuators (i.e. powering them) at the different positions (in block 202) and detecting either the vibrations from the actuators (e.g. as in the second and third examples in FIG. 1) or the motion of the wearer (e.g. as in the first example in FIG. 1), as recorded in the sensor data (received in block 204). In various examples, the actuators 102 may be removably mounted on the band 100 such that following a calibration phase which determines a pre-defined number of optimum positions, exactly that number of actuators 102 are placed onto the band. In an alternative mechanical arrangement, the actuators 102 may form links in within the band and may be connected together, along with non-actuator links, as part of the calibration phase.

In examples where the actuators are in fixed positions but are selectable, this may be achieved by selecting and activating one or more of the actuators on the wearable device and detecting either the vibrations from the actuators (e.g. as in the second and third examples in FIG. 1) or the motion of the wearer (e.g. as in the first example in FIG. 1).

In examples where the actuators 102 are movable relative to the wearable device (e.g. along the band 100 in the first example 302 in FIG. 3), the band may be shaped such that it defines a number of discrete positions for the actuators (e.g. through the use of locating protrusions and/or depressions in the band 100) or it may be possible to position the actuators 102 anywhere (e.g. at any point along the band 100).

In various examples the actuators 102 (from the plurality of actuators and in any of the wearable devices 10, 20, 30 shown in FIG. 1) may be adjustable relative to one another in terms of power in response to sensor data. By adjusting the relative power of the actuators, the efficacy of the actuation may be improved and hence the efficiency of the wearable device may be improved.

The power applied to the individual actuators may be varied in a number of different ways dependent upon the sensor data (where, as described above, the sensor data may provide a measure of either the vibrations from the actuators or the motion of the wearer). In various examples as part of a calibration phase, the same power may be applied to each of the actuators in turn and the vibrations detected using the sensors and then, in an operational phase (i.e. after the calibration phase) the relative power provided to each of the actuators may be adjusted such that less power is provided to those actuators where less vibration was detected in the calibration phase and more power is provided to those actuators where more vibration was detected in the calibration phase. This may, for example, result in power only being provided to a pre-defined number of actuators (e.g. N actuators, where N is an integer) which gave the largest detected vibration in the calibration phase or power only being provided to those actuators where the detected vibration in the calibration phase exceeded a pre-defined threshold value. In other examples, the power provided to an actuator in the operational phase may be (exactly or approximately) inversely proportional to the amount of detected vibration in the calibration phase.

In various examples the actuators 102 (from the plurality of actuators and in any of the wearable devices 10, 20, 30 shown in FIG. 1) may be adjustable relative to one another in terms of duty-cycle in response to sensor data, where this duty cycle, may for example be defined as a percentage of time that the actuator is activated in each 1 second period (or period of another pre-defined length). By adjusting the relative duty cycles of the actuators, the efficacy of the actuation may be improved as well as potentially improving the efficiency of the wearable device (e.g. since a lower duty cycle uses less energy than a higher duty cycle). The duty cycle may be adjusted to avoid fatigue or saturation. For example, a repeating pattern (e.g. like a heartbeat) may achieve the same effect (in terms of reduction in involuntary movement) as a continuous vibration (i.e. 100% duty cycle) but may be more bearable for a wearer. In various examples, a continuous vibration of the actuators may saturate the wearer's perception of the vibration, enabling them to filter out the sensation; however, the use of a repeating pattern (e.g. a duty cycle of less than 100%), and potentially a repeating pattern which changes over time, may prevent the wearer from filtering it out.

Over time, the duty cycle used to power the individual actuators may be varied and the effect of the changes in duty cycle on the motion of the wearer may be determined based on the sensor data (e.g. based on the detected involuntary muscle motion of the wearer). Over time, the duty cycle of the different actuators may therefore be adjusted to be set such that the involuntary muscle motion of the wearer is reduced.

In various examples, the duty cycle and patterns of the actuators may be varied over time and in parallel, the involuntary movement (e.g. tremors/involuntary vibrations) may be measured using the accelerometers. This measured data may then be analyzed to identify correlations between particular patterns and a decrease of involuntary movement (e.g. tremors). This analysis may be performed offline, by downloading the log files and processing them in the cloud, or on the device itself. In various examples, in addition to using accelerometer data, other sources of data may additionally be captured for analysis, including user feedback (e.g. there may be buttons on the device that the wearer presses when the vibration feels good, or appears to be working well for them). This additional data may assist in identifying correlations and then be fed back to control how the duty cycle, power and/or position of the actuators is adjusted (in block 206).

Whilst at least one of the duty cycle, power and/or position of the actuators relative to each other is adjusted based on sensor data, they may additionally be adjusted based on user input data which is obtained other than from the sensors, e.g. at least one of the duty cycle, power and/or position of the actuators relative to each other may be adjusted based on a combination of sensor data and additional user input data. In other examples at least one of the duty cycle, power and/or position of the actuators relative to each other is adjusted based on sensor data and another of the duty cycle, power and/or position of the actuators relative to each other may be adjusted based on user input data.

In the examples described above, the sensor(s) are described as detecting either the vibrations of one or more actuators or the involuntary movement of the wearer. In other examples, however, the sensor(s) may detect voluntary movement of the wearer, e.g. the sensor(s) may detect when the wearer is moving around and when they are stationary. In various examples, the sensor data may be used to detect when the user is stationary and the actuators may only be powered when the user is stationary (as determined by analysis of the sensor data). This may, for example, be used to increase the efficiency of the wearable device in situations where activation of the actuators is determined not to be as effective if the wearer is moving around.

In other examples, the sensor data may be used to determine other situations when the activation of the actuators (e.g. the therapeutic stimulation by the actuators) is not effective or is less effective and to prevent activation of the actuators in those situations. Alternatively, the sensor data may be used to identify situations when the activation of the actuators is most effective (e.g. to detect when the wearer picks up a stylus or other writing implement) and to activate the actuators only in those situations.

The situation-dependent control of the actuators may be implemented all the time or may, for example, be enabled when the remaining power of the wearable device falls below a threshold level. In various examples, as the remaining power of the wearable device reduces, the number of situations in which activation of the actuators is prevented may be increased (or the number of situations in which activation of the actuators is enabled may be decreased) in order to extend the operating life of the wearable device.

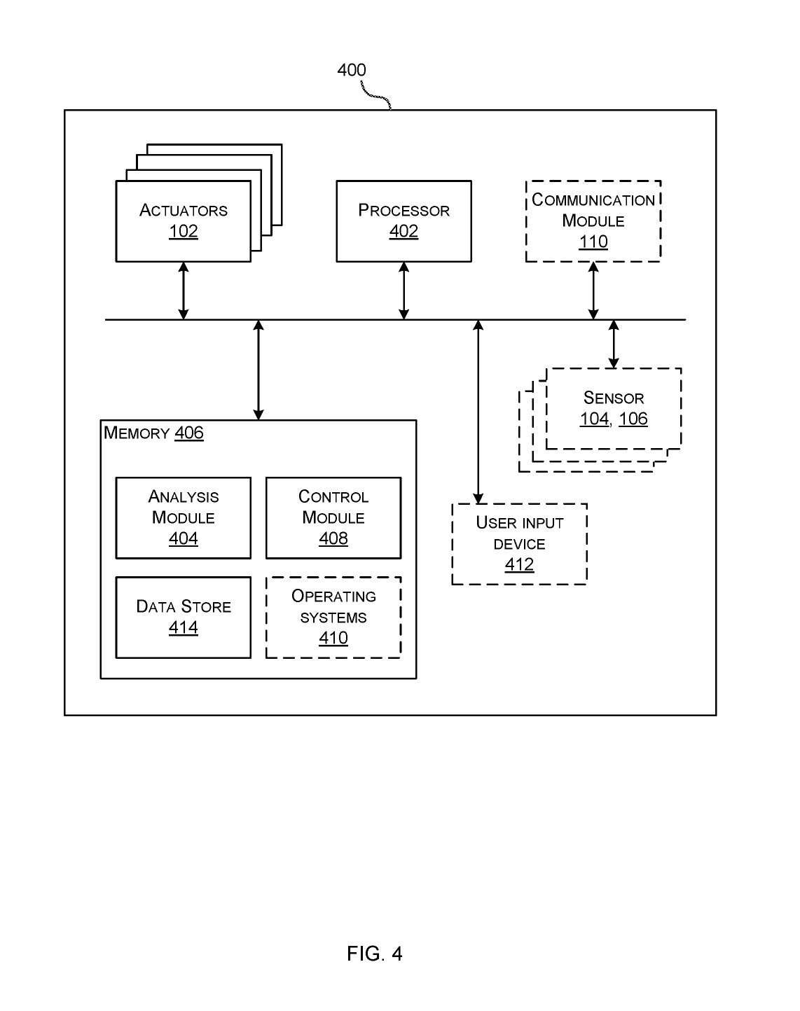

FIG. 4 shows a schematic diagram of a further example wearable device 400 which performs the analysis of the sensor data (in block 208). As shown in FIG. 4, the wearable device 400 comprises a plurality of actuators 102. In this example, the analysis of the sensor data (in block 208) is performed by a processor 402 that executes software of an analysis module 404 stored in memory 406 in the wearable device 400. The control of the duty cycle, power and/or position of the different actuators 102 may also be performed by the processor 402 that executes software of a control module 408 stored in memory 406 or alternatively control hardware (not shown in FIG. 4) may be provided within the wearable device 400.

The processor 204 may be a microprocessor, microcontroller or any other suitable type of processor for processing computer executable instructions to control the operation of the device in order to analyze the sensor data and optionally also control the operation of the actuators 102. In some examples, for example where a system on a chip architecture is used, the processor 102 may include one or more fixed function blocks (also referred to as accelerators) which implement a part of the method of analysis and/or control in hardware (rather than software or firmware). In various examples, platform software comprising an operating system 410 or any other suitable platform software may provided in the wearable device 400 and in such examples, the analysis module 404 and/or control module 408 may be part of the operating system 410 or application software that runs on top of the operating system 410. Alternatively, or in addition, the functionality described herein may be performed, at least in part, by one or more hardware logic components within the wearable device 400. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

Any computer executable instructions (such as the analysis module 404 and/or control module 408) which are executed by the processor 402 may be provided using any computer-readable media that is accessible by the wearable device 400. Computer-readable media includes, for example, computer storage media such as memory 406 and communications media. Computer storage media, such as memory 406, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device (such as the wearable device 400). In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 406) is shown within the wearable device 400 it will be appreciated that the storage is, in some examples, distributed or located remotely and accessed via a network or other communication link (e.g. using communication module 110).

As shown in FIG. 4, the memory 406 may further comprise a data store 414 and the data store 414 may, for example, be configured to store the sensor data and/or any parameters used to specify how the duty cycle, power and/or position of the actuators should be adjusted relative to each other in response to the sensor data.

As described above, the wearable device 400 may comprise one or more sensors 104, 106 or the sensors may be remote from the wearable device 400 and the sensor data may be received via a communication module 110. In examples where the sensors are remote from the wearable device and the analysis of the sensor data is performed remote from the wearable device, control signals may be received via the communication module 110 and these control signals may be interpreted by the processor 402 executing the control module software 408 in order to vary the duty cycle, power and/or position of the actuators 102 relative to each other.

In various examples, the wearable device 400 may comprise a user input device 412 and the analysis module 404 and/or control module 408 may receive user input data from the user input device 412 and this may be taken into consideration when adjusting the duty cycle, power and/or position of the actuators 102 relative to each other. In other examples, the wearable device 400 may receive user input data via the communication module 410 and the user input device may be remote from the wearable device 400 (e.g. it may be part of a computing device to which the wearable device 400 is tethered via a wireless link to the communication module 110).

Where provided, the user input device 412 may comprise NUI technology that enables a user to interact with the wearable device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (RGB) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

As described above, where the analysis module 404 and/or control module 408 are implemented in software (and executed by the processor 402) rather than being implemented in hardware, the software makes the wearable device 400 operate more efficiently and has an effect on a process outside the wearable device, i.e. the involuntary movement of the wearer of the wearable device 400.

In the examples described above, the duty cycle, power and/or position of the actuators in the wearable device are adjusted relative to each other based on sensor data. As described above, the duty cycle is distinct from the frequency at which an actuator vibrates. Depending upon the type of actuator, the frequency at which it vibrates may be pre-defined (e.g. LRAs vibrate most efficiently at their resonant frequency so there may be a control loop provided to keep the vibrations at resonance). In examples where the actuator does not have a pre-defined frequency of vibration, the methods described herein may additionally be used to adjust the frequency of vibration of the actuators relative to one another in response to sensor data.

In a variation on any of the examples described above, the actuators 102 may be movably mounted on the wearable device (e.g. as shown in the first example 302 in FIG. 3) and may be manually moved by a user or be moved automatically (e.g. using motors or other mechanism). In such a variation, the duty cycle and/or power of the actuators in the wearable device may optionally be adjusted relative to each other based on sensor data (which may reflect explicit user input) or based on a signal received from a computing device with which the wearable device communicates (e.g. a computing device to which the wearable device is tethered via a wireless link). For example, the tethered computing device may run an application that enables a user (e.g. the wearer of the wearable device) to adjust the duty cycle and/or power of each of the actuators and the tethered device may send control signals over the wireless link to cause the duty cycle and/or power of one or more of the actuators to be changed. In other examples, however, the duty cycle and power of the actuators in the wearable device may be fixed.

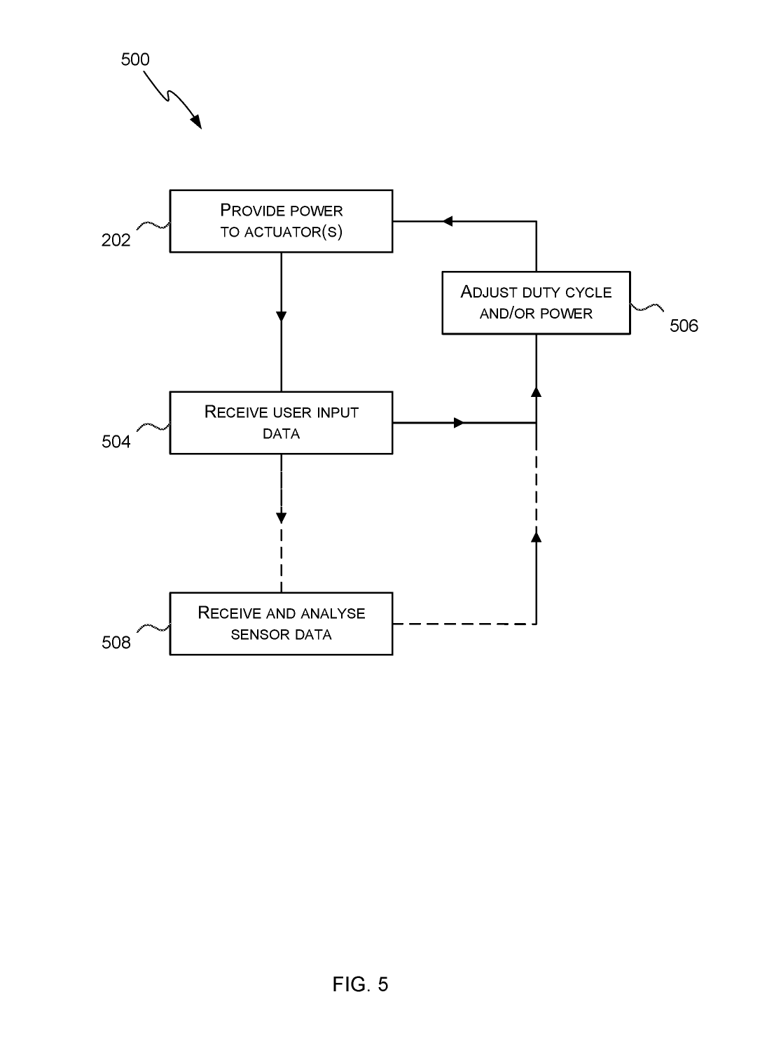

In various examples where the wearable device comprises a plurality of movably mounted actuators (102) such that a user can manually adjust their absolute and relative positions, the method of FIG. 2 may be modified as shown in FIG. 5. As shown in the method 500 in FIG. 5, the adjustment of duty cycle and/or power of one or more of the actuators (block 506) may be in response to user input data (received in block 504). The duty cycle and/or power of the actuators may, optionally, also be adjusted (in block 506) based on sensor data which is received and analysed (block 508).

Although the present examples are described and illustrated herein as being implemented in a wearable device which is worn around a limb, the wearable device described is provided as an example and not a limitation. As those skilled in the art will appreciate, the present examples are suitable for application in a variety of different types of wearable devices on various different parts of the body. For example, if the wearable device is to be worn close to the shoulder joint, it may be in the form of flexible patch that can be stuck onto the skin, instead of being wrapped around a limb, or the wearable device may be integrated into clothing (e.g. within the sleeve or leg of tight-fitting clothing).

In the examples described above, the therapeutic stimulation of the wearer is provided through the vibration of two or more actuators within the wearable device. In various examples, the wearable device may additionally comprise a second channel for the provision of therapeutic stimulation, such as an audio channel (e.g. the wearable device may additionally comprise a speaker or buzzer). This second channel may be controlled in response to the sensor data and may be controlled in a different way to the actuators. For example, the second channel may be activated and/or deactivated based on the sensor data. In an example, the second channel may provide audible tones at regular intervals (e.g. like a metronome) and this may be activated in response to detecting that the user is moving or turning based on analysis of the sensor data.

Furthermore, it will be appreciated that the wearable device as described herein may comprise functionality in addition to the provision of therapeutic stimulation (as described above). For example, the wearable device may also function as a watch (e.g. it may display the time and/or function as a smart watch and provide additional alerts/information in conjunction with a smart phone to which it is tethered via a wireless link) and/or an activity and/or sleep tracker.

A first further example provides a wearable device comprising a plurality of actuators, wherein the actuators are movably mounted on the wearable device such that the positions of the actuators are adjustable relative to one another.

In the first further example, the actuators may be adjustable relative to one another in terms of their duty cycle and/or power based on sensor data and/or user input.

A second further example provides a wearable device comprising a plurality of actuators, wherein the actuators are adjustable relative to one another in terms of their duty cycle, power and/or position based on sensor data.

In the second further example, one or more of the actuators may be movably mounted on the wearable device. In addition (or instead), one or more of the actuators may be located in fixed positions on the wearable device and may be adjustable relative to one another in terms of position based on sensor data by selecting and activating a subset of the actuators based on the sensor data.

Alternatively or in addition to the other examples described herein, the first or second further examples may include any combination of one or more of the following aspects:
the wearable device may further comprise one or more sensors spatially separated from the plurality of actuators and configured to generate the sensor data.
the wearable device may further comprise a plurality of sensors, wherein one of the plurality of sensors is located proximate to each of the plurality of actuators.
the wearable device may further comprise a communication module arranged to receive sensor and/or control data via a wireless link.
the wearable device may further comprise an analysis module arranged to analyze the sensor data and to generate control data specifying a change to the duty cycle, power or position of one or more of the actuators. The control data may identify a plurality of positions on the wearable device or a subset of the actuators.
the wearable device may further comprise a control module arranged to adjust the duty cycle, power or position of one or more of the actuators in response to control data generated based on the sensor data.
the control data may identify a plurality of positions on the wearable device and the control module is arranged to activate an actuator close to each of the identified positions.
the control data may identify a plurality of positions on the wearable device and the control module is arranged to trigger movement of one or more actuators until an actuator is positioned close to each of the identified positions.
The actuators may be adjustable relative to one another in terms of their duty cycle, power and/or position based on a combination of sensor data and user input data.
the wearable device may further comprise a user input device configured to generate user input data in response a user input.
the actuators may be adjustable relative to one another in terms of their duty cycle, power and/or position based on sensor data to improve efficacy and/or efficiency of the wearable device.
in use, the wearable device may be arranged to reduce involuntary movements of a wearer of the device by activation of two or more of the plurality of actuators.

A third further example provides a system comprising: a wearable device comprising a communication module and a plurality of actuators, wherein the actuators are adjustable relative to one another in terms of their duty cycle, power and/or position based on sensor data; and one or more sensors separate from the wearable device and arranged to generate the sensor data.

A fourth further example provides a system comprising: a wearable device comprising a communication module and a plurality of actuators, the actuators are movably mounted on the wearable device such that the positions of the actuators are adjustable relative to one another.

The system of the third or fourth further example may additionally comprise a computing device comprising the one or more sensors and wherein the computing device is arranged to communicate sensor data and/or control data to the wearable device via the communication module.

A fifth further example provides a method of operating a wearable device, the method comprising: activating one or more actuators in a wearable device; and adjusting a duty cycle, power and/or position of one or more of the actuators in the wearable device based on sensor data.

The method of the fifth further example may further comprise any combination of one or more of the following aspects:
the method may further comprise receiving sensor data generated by one or more sensors during activation of the actuators in the wearable device; and analyzing the sensor data.
adjusting a duty cycle, power and/or position of one or more of the actuators in the wearable device based on sensor data may comprise: selecting a subset of the actuators in the wearable device based on the sensor data; and activating the selected subset of actuators.

A sixth further example provides a method of operating a wearable device, the method comprising: activating one or more movably mounted actuators in a wearable device; and adjusting a duty cycle and/or power of one or more of the actuators in the wearable device based on control data received via a wireless link.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

This acknowledges that software is a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A wearable device comprising a plurality of actuators, wherein the actuators are movably mounted on the wearable device such that the positions of the actuators are adjustable relative to one another.

2. A wearable device according to claim 1, wherein the actuators are adjustable relative to one another in terms of their duty cycle and/or power based on sensor data.

3. A wearable device according to claim 1, wherein the actuators are adjustable relative to one another in terms of their duty cycle and/or power in response to user input.

4. A wearable device comprising a plurality of actuators, wherein the actuators are adjustable relative to one another in terms of their duty cycle, power and/or position based on sensor data.

5. A wearable device according to claim 4, wherein the actuators are movably mounted on the wearable device.

6. A wearable device according to claim 4, wherein the actuators are located in fixed positions on the wearable device and are adjustable relative to one another in terms of position based on sensor data by selecting and activating a subset of the actuators based on the sensor data.

7. A wearable device according to claim 4, further comprising one or more sensors spatially separated from the plurality of actuators and configured to generate the sensor data.

8. A wearable device according to claim 7, further comprising a control module arranged to adjust the duty cycle, power or position of one or more of the actuators in response to control data generated based on the sensor data.

9. A wearable device according to claim 8, wherein the control data identifies a plurality of positions on the wearable device and the control module is arranged to:
activate an actuator close to each of the identified positions; or
trigger movement of one or more actuators until an actuator is positioned close to each of the identified positions.

10. A wearable device according to claim 4, further comprising a plurality of sensors, wherein one of the plurality of sensors is located proximate to each of the plurality of actuators.

11. A wearable device according to claim 4, further comprising a communication module arranged to receive sensor and/or control data via a wireless link.

12. A wearable device according to claim 4, further comprising an analysis module arranged to analyze the sensor data and to generate control data specifying a change to the duty cycle, power or position of one or more of the actuators.

13. A wearable device according to claim 12, wherein the control data identifies a plurality of positions on the wearable device or a subset of the actuators.

14. A wearable device according to claim 4, wherein the actuators are adjustable relative to one another in terms of their duty cycle, power and/or position based on a combination of sensor data and user input data.

15. A wearable device according to claim 14, further comprising a user input device configured to generate user input data in response a user input.

16. A wearable device according to claim 4, wherein the actuators are adjustable relative to one another in terms of their duty cycle, power and/or position based on sensor data to improve efficacy and/or efficiency of the wearable device.

17. A wearable device according to claim 4, wherein in use, the wearable device is arranged to reduce involuntary movements of a wearer of the device by activation of two or more of the plurality of actuators.

18. A method of operating a wearable device, the method comprising:
activating one or more actuators in a wearable device; and
adjusting a duty cycle, power and/or position of one or more of the actuators in the wearable device based on sensor data.

19. The method according to claim 18, further comprising:
receiving sensor data generated by one or more sensors during activation of the actuators in the wearable device; and
analyzing the sensor data.

20. The method according to claim 18, wherein adjusting a duty cycle, power and/or position of one or more of the actuators in the wearable device based on sensor data comprises:
selecting a subset of the actuators in the wearable device based on the sensor data; and
activating the selected subset of actuators.
